(19) United States
(12) Patent Application Publication
(10) Pub. No.: US 2009/0014606 A1
(43) Pub. Date: Jan. 15, 2009

(54) Display Assembly With Locking Mechanism

(75) Inventor: Charles Robert Kelly, Wilmington, DE (US)

Correspondence Address: ALIX YALE & RISTAS LLP, 750 MAIN STREET, SUITE 1400, HARTFORD, CT, 06103, US

(73) Assignee: STRUCTURAL GRAPHICS, LLC, Essex, CT (US)

(21) Appl. No.: 12/223,751

(22) PCT Filed: Feb. 7, 2007
(86) PCT No.: PCT/US2007/003141

§ 371 Date: Aug. 6, 2008

Related U.S. Application Data
(60) Provisional application No. 60/765,798, filed on Feb. 7, 2006.

(51) Int. Cl. F16M 11/00; E05C 1/02

(52) U.S. Cl. 248/174; 292/137

(57) ABSTRACT

A foldable display stand or a display package incorporates a releasable sliding locking mechanism. The locking mechanism comprises a folded portion which forms a pair of latching members which engage in a die-cut button opening of a panel for locking the sliding member in position. The locking mechanism may be released by depressing the latch to disengage from the opening. The sliding locking mechanism is also applicable in conjunction with locking struts for erecting a display stand.

### CROSS-REFERENCE TO RELATED APPLICATION

This application is the U.S. national phase of International PCT Application No. PCT/US2007/003141 filed on Feb. 7, 2007 which claims the priority of U.S. Provisional Application 60/765,798 filed Feb. 7, 2006.

### BACKGROUND

This disclosure relates generally to inexpensive display stands which may easily be transformed from a flat configuration to a generally stable, upright configuration and to sliding display packages.

### SUMMARY

Briefly stated, a display stand comprises a panel foldable to form two layers having a support edge and opposed first and second ends. A first member extends from the first edge and comprises an integral first lock portion. A second member integrally extends from a second end and comprises an integral cooperative second lock portion and slidably receives the first member. Opposite ends are urged toward each other so that the first and second lock portions slidably interlock in an interior location surrounded by at least two sides of the panel, and the panel is positioned upon a stable upright orientation along the support edge.

A multiple modular display stand may comprise a pair of display stands which are hingeably connected together. The first lock portion preferably comprises a panel defining an opening. The second lock portion comprises a tongue and a pair of opposed edge portions folded generally toward each other to form a pair of latch members. The latch members are received in the opening and engage an edge of the opening. The tongue may be depressed to release the latch members from the opening. The latch members urge the second lock portion into the opening. The first and second members are cooperative support struts.

A sliding lock assembly comprises a sleeve having a pair of opposed cover panels and an opening defined in one panel. A sliding panel is disposed between the cover panels and is slidably displaceable relative to the cover panels. A sliding panel has an integral projecting latch with a pair of opposed folded sides. The latch is alignable with the opening and engageable with one panel so that the sliding panel is displaceable, whereby the latch engages into the opening and locks the panel against sliding and movement in a first direction. The latch may be depressed to disengage the opening to permit the sliding panel to move in the first direction. A perforation portion facilitates severing the latch from the remaining sliding panel portion. An opening is formed in the sliding panel.

The cover panels and sliding panel cooperate to form a display package. A display stand enclosure preferably surrounds the lock assembly. The sleeve and sliding panel integrally extend from opposed portions of the enclosure. The enclosure is four-sided and the sleeve and sliding panel extend from opposing vertices of the enclosure. The cover panel opening is substantially rectangular. One panel has an exterior surface and a portion of the latch projects through the opening beyond the exterior surface.

### BRIEF DESCRIPTION OF THE DRAWINGS

FIG. 1 is a front perspective view of a representative display stand in an erected upright orientation for usage;

FIG. 2 is a generally top view of the erected display stand of FIG. 1;

FIG. 3 is a layout view, partly in broken lines to show fold lines, of a pre-form stage of the display stand of FIG. 1 prior to assembly and in an unfolded stage;

FIG. 4 is a plan view, partly in broken lines to show fold lines, of a representative display stand and showing a flat configuration for shipping prior to usage;

FIG. 5 is an enlarged, interior, perspective side view illustrating an automatic locking mechanism of the display stand of FIG. 1 prior to erection;

FIG. 6 is an enlarged, perspective side view showing the automatic locking mechanism of FIG. 5 being moved toward an actuated position;

FIG. 7 is an enlarged, perspective side view showing the automatic locking mechanism of FIG. 5 in a locked position;

FIG. 8 is an enlarged, cross-sectional view of the automatic locking mechanism of FIG. 7;

FIG. 8A is an enlarged, fragmentary, longitudinal, sectional view of the automatic locking mechanism of FIG. 7;

FIG. 9 is a front perspective view of a second embodiment of a display stand;

FIG. 9A is a generally top view of the display stand of FIG. 9;

FIG. 10 is a front perspective view of a third embodiment of a display stand;

FIG. 10A is a generally top view of the display stand of FIG. 10;

FIG. 11 is a front perspective view of a fourth embodiment of a display stand;

FIG. 11A is a generally top view of the display stand of FIG. 11;

FIG. 12 is a front perspective view, partly in diagrammatic form, of a fifth embodiment of a display stand;

FIG. 12A is a generally bottom plan view of the display stand of FIG. 12 with the top panel in a fully closed position;

FIG. 13 is a front perspective view, of a sixth embodiment of a display stand;

FIG. 13A is a generally top view of the display stand of FIG. 13;

FIG. 14 is a front perspective view of a multi-modular display stand;

FIG. 14A is a generally top view of the display stand of FIG. 14;

FIG. 15 is a perspective view, partly in diagrammatic form, illustrating a partly folded modular configuration form for the display stand of FIG. 14;

FIG. 16 is a perspective view, partly in diagrammatic form, illustrating the unfolded module configuration and partial erection of the display stand of FIG. 14;

FIG. 17 is a layout view, partly in broken lines to show fold lines, illustrating an unfolded, unassembled form for the display stand of FIG. 14 prior to transformation to the configuration of FIG. 15 and further illustrating how the display stand is constructed;

FIG. 18 is a perspective view of a display card incorporating a sliding locking mechanism in a locked position;

FIG. 19 is a perspective view of the display package of FIG. 18 in an unlocked position;

FIG. 20 is an enlarged fragmentary view of the display package and locking mechanism of FIG. 19;

FIG. 21 is an enlarged, fragmentary, longitudinal, sectional view of the package and locking mechanism of FIG. 18; and

FIG. 22 is a perspective view, partly in diagram form, of a second embodiment of a display package.

### DETAILED DESCRIPTION OF THE PREFERRED EMBODIMENTS

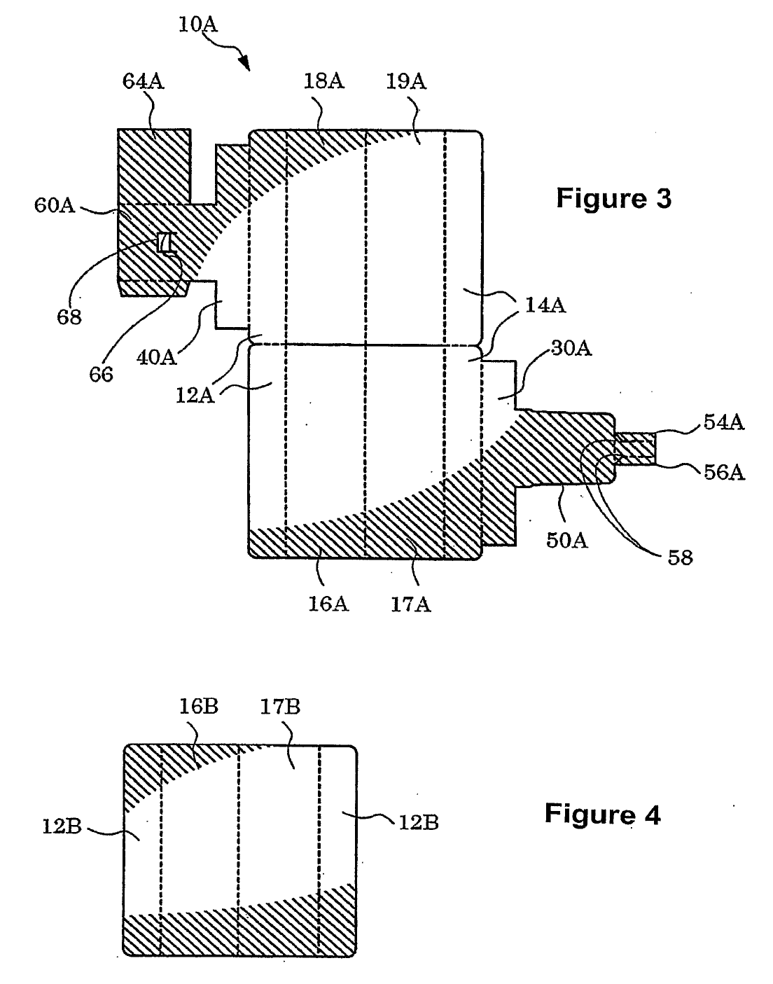

With reference to the drawings wherein like numerals represent like parts throughout the several figures, a display stand incorporates an interior projectable strut having an automatic locking mechanism and is generally designated by the numeral 10. Display stand 10 in one preferred embodiment may be generally formed from a single sheet of material 10A which is cut, such as shown in FIG. 3, folded and assembled to form a flat configuration 10B for packaging and shipping, such as illustrated in FIG. 4.

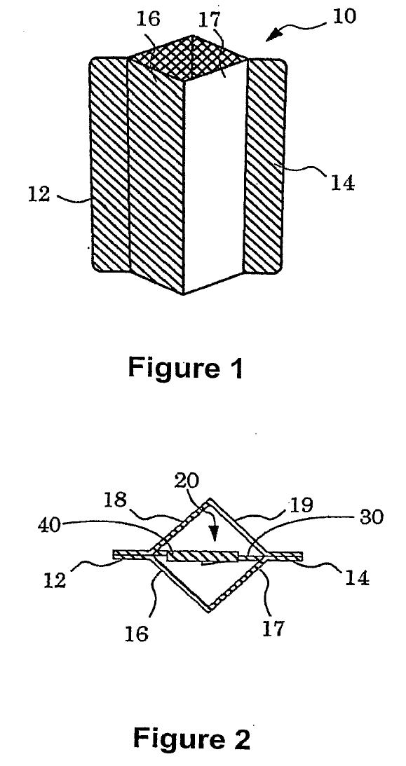

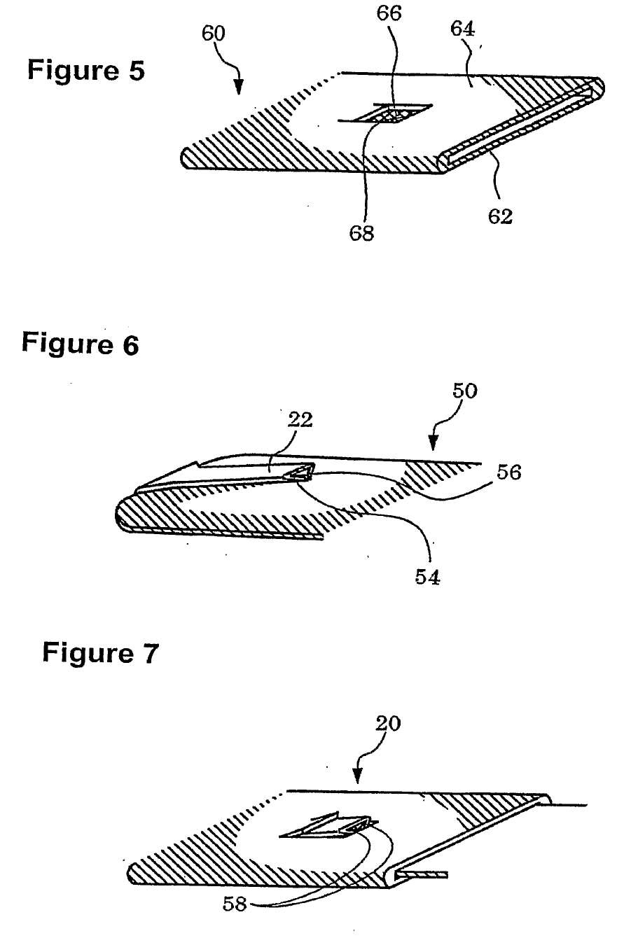

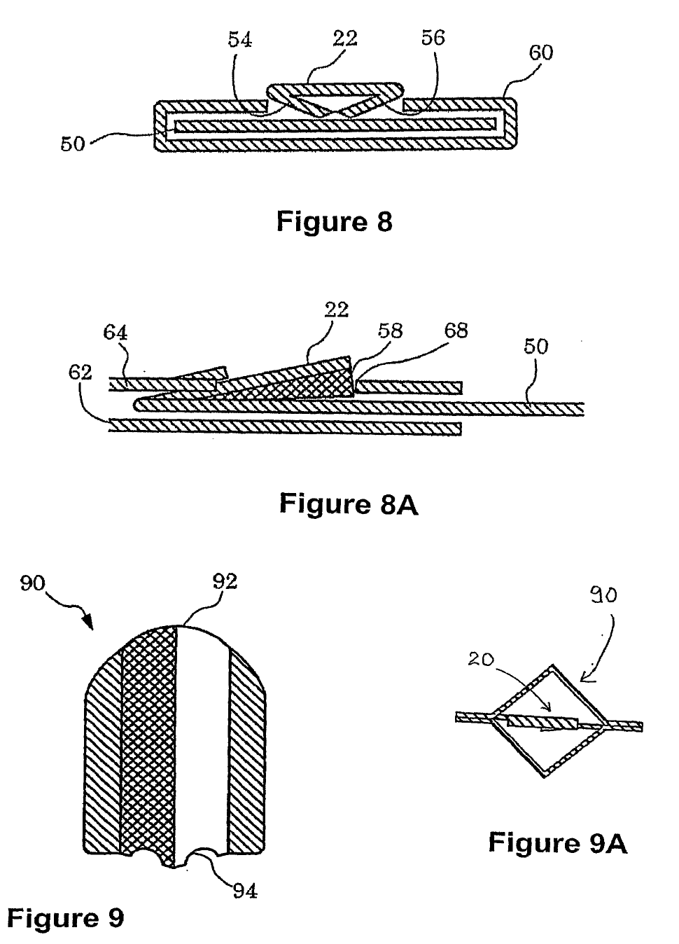

On arrival at the point of usage, the compact folded display stand may be relatively easily transformed to an erected form by pushing wing tabs 12 and 14 at opposed vertices, as illustrated in FIGS. 1 and 2, to activate an interior automatic locking mechanism 20, as best illustrated in FIGS. 5-8. The locking mechanism locks a pair of cooperative support strut members 30 and 40 at a fixed position. The stand is thus locked to form a stable rectalinear column having sides 16, 17, 18 and 19 for many of the preferred embodiments. The locked form of the automatic locking mechanism 20 may be easily released by depressing a formed release button 22 (FIG. 7) and pulling the wing tabs 12, 14 away from each other so that the display stand may be collapsed back to the flattened state as illustrated in FIG. 4. The form of the corresponding elements in the FIGS. 3 and 4 stages are designated by appending the letters A and B, respectively.

The automatic locking mechanism 20 and struts 30 and 40 are interior structures which are not readily visible exteriorly from the sides 16-19 of the stand. Strut member 30 comprises a tongue 50 extending interiorly from one of the sides. Strut member 40 comprises a sleeve 60 extending from another side. The tongue 50 is slidably received in the sleeve 60 which is formed by a pair of panels 62 and 64. Panel 64 includes a central opening 66 which at edge 68 forms a catch. The distal tip portion of the tongue is folded to form a pair of latch members 54, 56 which at their proximal end form an angled pair of engagement ends 58. The tongue 50 is inserted into the sleeve 60. The latch members extend and are biased outwardly so that the engagement ends 58 engage the rear edge defining the catch 68 of the slot opening to thereby lock the tongue 50 in sleeve 60 and hence fix the position between diagonally opposed vertices of the sides.

The tongue/sleeve combination functions as a support strut when locked. On depression of the tab 22 and a slight inward motion, the ends 58 are released from the catch and pressed inwardly along the angled edge to clear the edge of the catch 68 to permit the stand to be collapsed to the flattened configuration of FIG. 3.

A number of possible variants of the display stand are illustrated in FIGS. 9-13.

Display stand 90 illustrated in FIG. 9 is substantially similar in form and function to display stand 10 except for the upper and lower profiles which are die cut at 92 and 94 to form a striking silhouette.

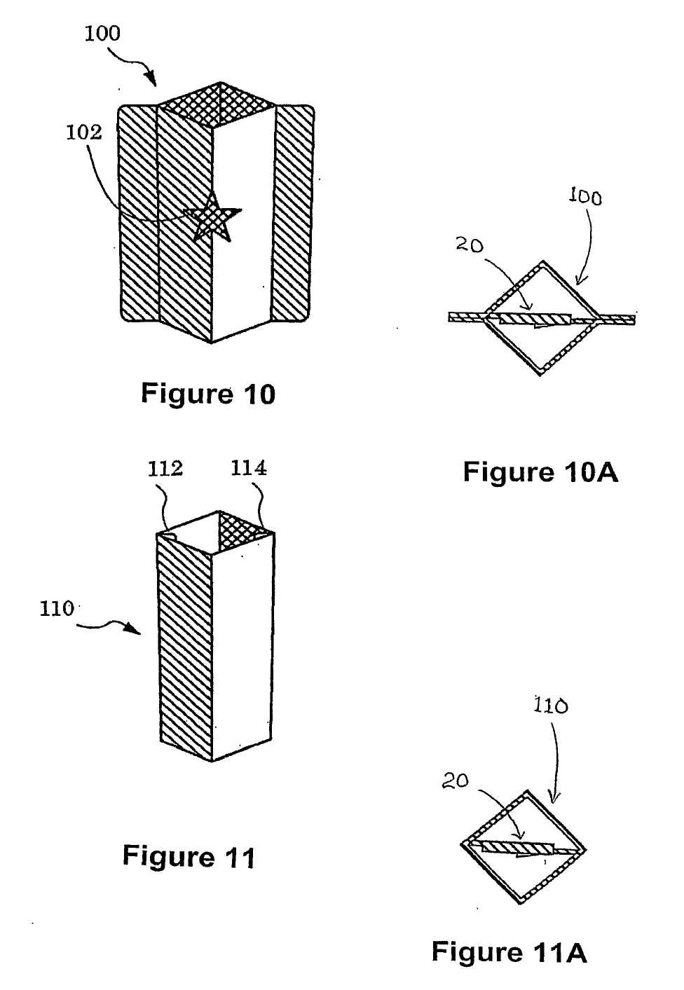

Display stand 100 illustrated in FIG. 10 is substantially similar to display stand 10 except that it includes die a cut opening 102. The opening 102 may reveal interior printing of text or indicia which is fixed to the sleeve 60 of the central locking mechanism or the interior surface of the panel opposite the openings.

Display stand 110 illustrated in FIG. 11 is similar to display stand 10 except that the wing tabs 112 and 114 are folded so that they extend on the inside of the four sided enclosure of the stand. Only portions of the interior wing tabs 112 and 114 are illustrated.

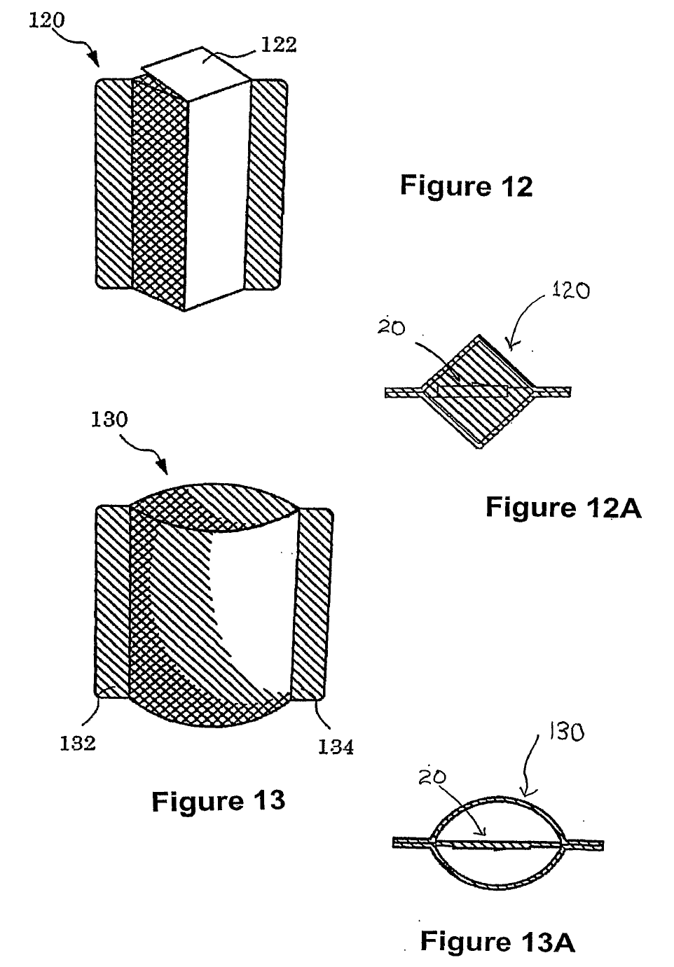

Display stand 120 illustrated in FIG. 12 is substantially similar to display stand 10 except that it also includes a cover flap 122 which can be folded (as illustrated by the arrow) to function as a cover or an end cap for the display stand.

Display stand 130 illustrated in FIG. 13 is substantially similar to that previously described for display stand 10, except the stand has an overall cylindrical shape with opposed projecting wings 132 and 134.

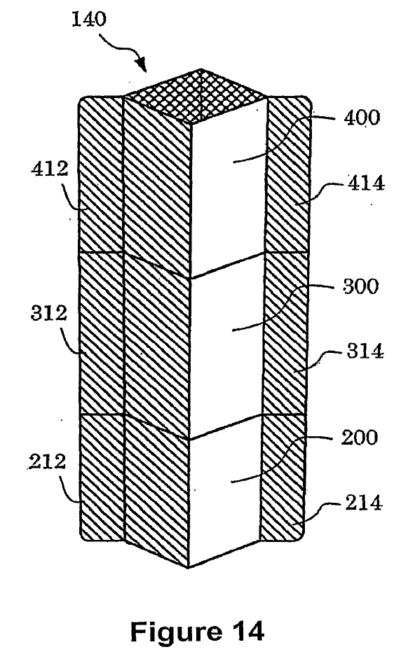

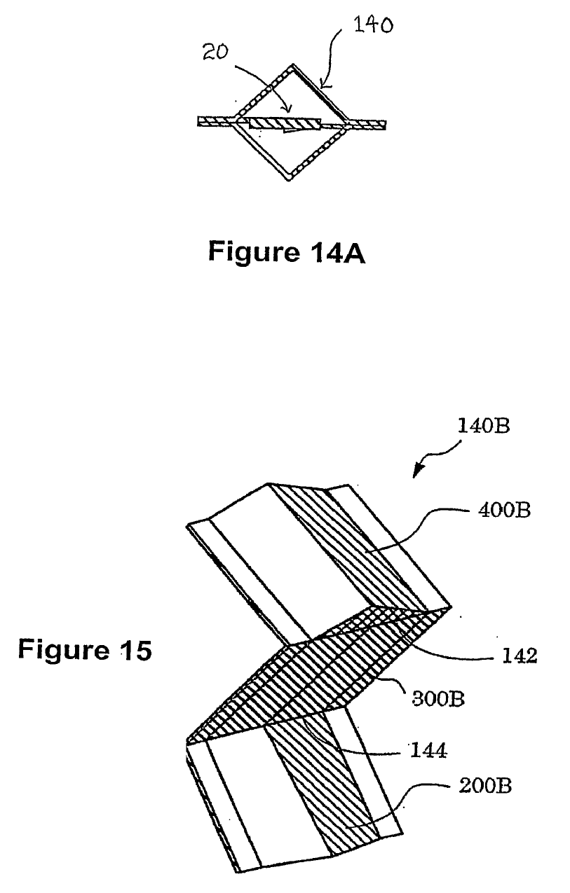

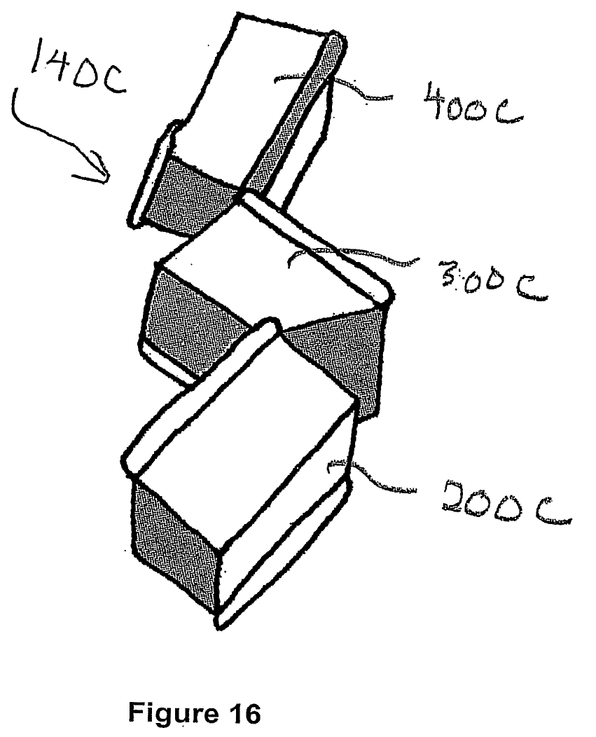

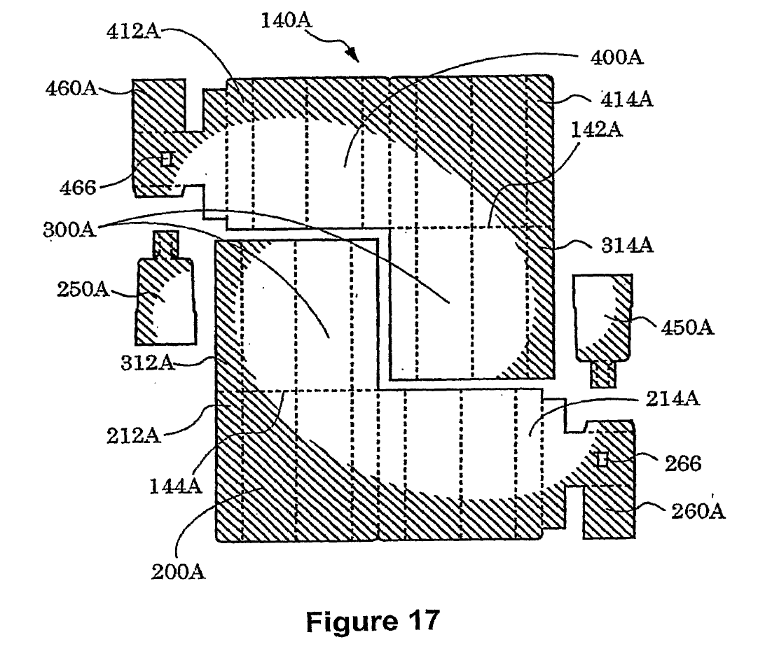

Display stand 140 illustrated in FIGS. 14-17 is similar in form and function to display stand 10 except that three modules 200, 300 and 400 are hinged together at hinges 142 and 144 as illustrated in FIGS. 15 and 16. A representative layout view of the components in the unfolded state is illustrated in FIG. 17 wherein the corresponding components are designated with corresponding lead numerals 2, 3 and 4 respectively and the letter A. The flattened, pre-assembled configuration similar to FIG. 4 (except for the multiple layers of modules) may be expanded and unfolded to stages 140B and 140C as shown in FIGS. 15 and 16. The wing tab pairs 212, 214 and 312, 314 and 412, 414 are pulled apart to lock the stand 140 in an extended, upright configuration as illustrated in FIG. 14. Modules 200 and 400 include an interior projectable strut assembly with an automatic sliding locking mechanism. Adhesive may be employed to connect the separate components.

It will be appreciated that each of the display stands may be shipped in the flattened configuration to the point of usage. The stands are then snapped to the erected configuration by pushing the wing tabs toward each other whereby the automatic locking mechanism locks the stand in a stable configuration. The stands may be used as retail advertising displays, as tabletop displays, as floor displays and for numerous other applications.

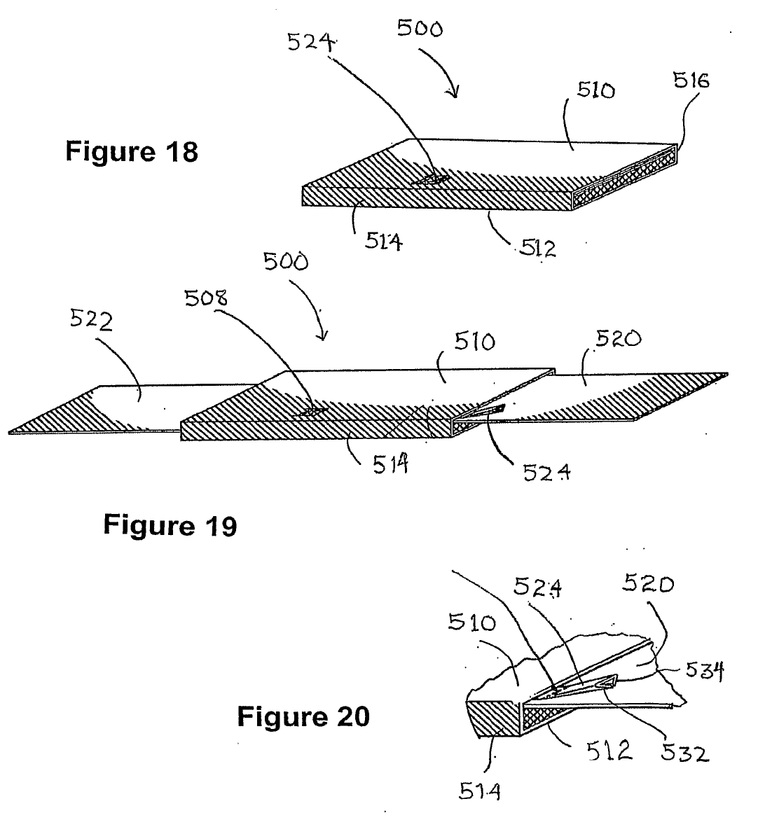

With reference to FIGS. 18 through 21, a display package which incorporates a sliding locking mechanism is generally designated by the numeral 500. The display package is preferably formed from lightweight cardboard or other similar material which is foldable, but retains a rigid construction and has, in a preferred embodiment, a dimension of 3 inches by 6 inches by ⅜ inches. The display package 500 comprises a box-like sleeve having opposed main panels 510 and 512 which are spaced apart by opposed narrow side panels 514 and 516. A sleeve may be formed from light-weight cardboard which is folded to the desired shape and cut to the desired dimensions.

A sliding panel 520 is dimensioned for reception in the sleeve and for longitudinal movement with respect to the sleeve. Sliding panel 520 may be linked to an opposing reciprocating panel 522. One panel 510 of the sleeve has a die-cut button opening 508 which is generally rectangular in shape and has an edge 509 which cooperates with the opening to form a catch. The sliding panel 520 has a folded over portion with a forward extension forming a latch 522 comprising defining a central strip 530 and a pair of folded down side latch members 532 and 534. The latch members 532 and 534 are configured and/or the latch is folded so that the forward latch protrusion is generally urged upwardly against the underside of panel 510.

The latch 524 is integral with the sliding panel 520, with reference to FIG. 22, panel 520 may have an opening 526 and panel 510 may have a complementary cut-out 518 to facilitate grasping and displacement of the panel relative to the sleeve. When the latch 524 is longitudinally displaced rearwardly, i.e., generally to the left in FIGS. 18-22, so that the forward portion of the latch clears the underside of the opening and the panel 520 is then displaced forwardly into the direction of the FIG. 22 arrow, the latch is engaged against the front edge 509 or the catch of the die-cut button opening 508 to essentially lock sliding panel 520 against forward movement relative to the sleeve in the direction of the arrow (and panel 522 against opposing movement). Distal portions of the latch members and tongue are essentially received in the opening 508 and slightly protrude above the surface of sleeve panel 510. When the latch is depressed and the sliding panel 520 is displaced in the direction of the arrow, the latch ends disengage from the opening 508 and clear the catch 509 to allow the panel to be forwardly moved.

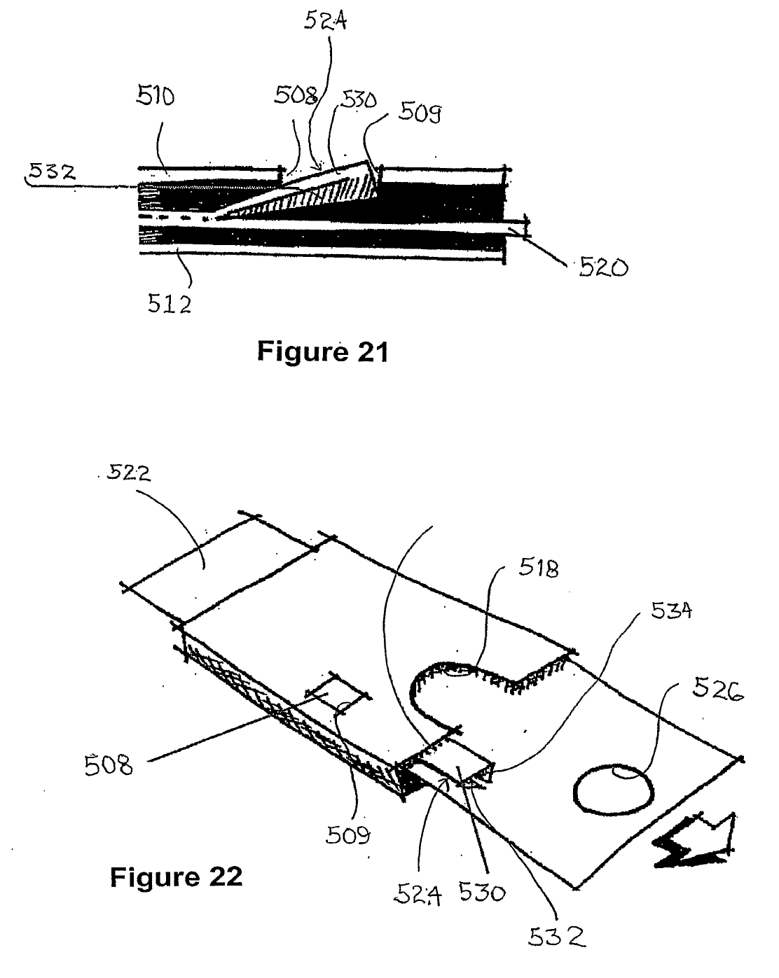

A perforation 540 may be formed at the intersection of the latch 524 so that the latching extension may be easily severed and removed from the remainder of the sliding panel after it is released from the locking position, as best illustrated in FIGS. 20 and 21. This functions to provide an efficient tamperproof/childproof feature for the package.

What is claimed:

1. A sliding lock assembly comprising:
a sleeve having a pair of opposed cover panels and an opening defined in one panel;
a sliding panel disposed between said cover panels and slidably displaceable relative to said cover panels, said sliding panel having an integral projecting latch having a pair of opposed folded sides, said latch being alignable with said opening and engageable with said one panel so that said sliding panel is displaceable whereby said latch slides into said opening and locks said panel against sliding movement in a first direction.

2. The sliding lock assembly of claim 1 wherein said latch may be depressed to disengage said opening to permit said sliding panel to move in said first direction.

3. The sliding lock assembly of claim 1 further comprising a perforation portion to facilitate severing said latch from said remaining sliding panel portion.

4. The sliding lock assembly of claim 1 further comprising an opening in said sliding panel.

5. The sliding lock assembly of claim 1 wherein said cover panels and sliding panel cooperate to form a display package.

6. The sliding lock assembly of claim 1 and further comprising a display stand enclosure surrounding said lock assembly.

7. The sliding lock assembly of claim 6 wherein said sleeve and sliding panel integrally extend from opposing portions of said enclosure.

8. The sliding lock assembly of claim 6 wherein said enclosure is four-sided and said sleeve and sliding panel extend from opposing vertices of said enclosure.

9. The sliding lock assembly of claim 1 wherein said cover panel opening is substantially rectangular.

10. The sliding lock assembly of claim 1 said one panel has an exterior surface and a portion of said latch projects through said opening beyond said exterior surface.

11. A display stand comprising:
a panel foldable to form two layers having a support edge and opposed first and second ends;
a first member extending from said first end and comprising an integral first lock portion; and
a second member integrally extending from said second end and comprising an integral cooperative second lock portion and slidably receiving said first member;
wherein said opposite ends may be urged toward each other so that said first and second lock portions slidably interlock in an interior location surrounded by at least two sides of said panel and said panel is positionable in a stable upright orientation along said support edge.

12. A multiple modular display stand comprising:
a pair of display stands as recited in claim 11 and hingeably connected together.

13. The display stand of claim 11 wherein said first lock portion comprises a panel defining an opening.

14. The display stand of claim 13 wherein said second lock portion comprises a tongue and a pair of opposite edge portions folded generally toward each other to form a pair of latch members.

15. The display stand of claim 14 wherein said latch members are received in said opening and engage an edge of said opening.

16. The display stand of claim 10 wherein said tongue may be depressed to release said latch members from said opening.

17. The display stand of claim 15 wherein said latch members urge said second lock portion into said opening.

18. The display stand of claim 11 wherein said first and second members are cooperative support struts.
